(19) United States
(12) Patent Application Publication
(10) Pub. No.: US 2005/0080685 A1
(43) Pub. Date: Apr. 14, 2005

(54) Internet commerce access security system and method

(76) Inventor: Scott Blum, Jackson, WY (US)

Correspondence Address: Mitchell P. Brook, Esq., Suite 200, 11988 El Camino Real, San Diego, CA, 92130, US

(21) Appl. No.: 10/752,383

(22) Filed: Jan. 5, 2004

Related U.S. Application Data
(60) Provisional application No. 60/510,170, filed on Oct. 9, 2003.

(51) Int. Cl. G06F 17/60

(52) U.S. Cl. 705/26

(57) ABSTRACT

A system and method of conducting electronic commerce is provided in which phantom advertising response clicks are reduced by inhibiting automated click-through access to an advertised Internet website. A security system is provided that makes it difficult, if not impossible, for automated systems to gain click-through access to an advertised Internet website without human intervention. An interim landing page is provided by the retailer to generate click counts reducing the phantom percentage contained. Passage through the interim landing page is required in order to gain access to the retailer's advertised web page.

### CROSS REFERENCE TO RELATED APPLICATION

Priority is claimed to Provisional Patent Application Ser. No. 60/510,170, filed Oct. 9, 2003, the contents of which are incorporated herein by reference.

### FIELD OF THE INVENTION

The present invention relates to a system for inhibiting web crawler or automated access to an Internet commerce website via an access security system and method.

### BACKGROUND OF THE INVENTION

E-commerce is a growing field with specialized Internet retailers such as Amazon.Com, Buy.Com and Internet websites of brick and mortar retailers, such as Macys.com vying for consumer traffic and sales. Various forms of advertising via the Internet are available to market and otherwise promote consumer access and shopping on websites. Examples are banner ads, pop-ups, and search engine listings.

One type of search engine available to consumers is the price engine. Price engines are websites that provide listings of prices available on products, as sold by different Internet retailers. For example, if a consumer is interested in a particular digital camera, the consumer can conduct a search on a price engine for the camera model and receive a comparative listing of prices available from particular retailers. Retailers make their prices and direct links available for listing on the price engines and frequently pay a fee for display on the price engine listing, or for enhanced placement, graphic ads or combinations thereof. Examples of price engines are MySimon and Pricegrabber.

One form of fee structure for price engines is a pay-by-click fee structure. In such a fee structure, clicks by users from the price engine are tracked by either the target retailer or by the price engine company, or both. The retailer pays for each click, the rationale being that each click represents a potential consumer or sale for the retailer.

Other forms of Internet advertising also are provided using pay-by-click fee structures. For example, banner advertising is provided on many websites in which one form of pricing is pay-by-click. Pay-by-click fees also may be generated by Internet search engines. In this example, an advertiser may pay a fee for prominent placement or other selected placement in a search results listing. One example of such a fee structure is the Overture search engine. In this example, advertisers bid on pay-by-click fees for particular search terms. The highest bidder can receive the first place in the search results list. In addition, search engines or price engines can restrict their search results only to paying advertisers.

A pay-by-click system requires a landing page Internet address (e.g., a URL) to be provided as the click-through location. The number of clicks through to the landing page are counted either by the retailer at the landing page, and/or by the advertising provider, and hence a click count is generated.

One problem with the pay-by-click fee structure for price engines and other forms of Internet advertising is justifying a fair price to the advertising purchaser. This particularly arises in instances where clicks are not generated by legitimate consumers or legitimate “window” shoppers. When this occurs, there are clicks generated that do not serve the advertising purpose of the pay-by-click fee, incurring unfair expense to the advertiser. Such phantom clicks also impair accurate tracking or advertising success and market measurement. They also can lead to disputes between the advertising sellers and the retailer advertising purchasers over the number of real clicks, for which a pay-by-click fee is owed and the number of illegitimate or phantom clicks. In this description, clicks generated by sources other than legitimate consumers or “window” shoppers are called “phantom” clicks.

There are numerous sources of this problem of phantom clicks. One source is automated programs or systems known as web-crawlers, spiders, Internet robots or colloquially “bots”. These are automated systems or software programs that are operated to gather data via the Internet. For example, search engine companies such as Google are known to operate automated systems that gather Internet data via clicking on links to discover and compile databases of Internet websites and data. Other sources of phantom clicks are notorious, such as from disgruntled individuals, disgruntled suppliers or competitors seeking to raise advertising expenses by clicking and causing pay-by-click advertising costs.

Accordingly, there is a need for a system to protect advertisers such as retailers and advertising suppliers from phantom clicks, in order to provide more accurate click counts, reduce pay-by-click fee disputes, and increase the accuracy of market data and advertising effectiveness evaluations.

### SUMMARY OF THE INVENTION

The present invention alleviates to a great extent the disadvantages of the known pay-by-click advertising systems by providing a system and method of reducing phantom clicks by inhibiting automated click-through access to an advertised Internet website. A security system is provided that makes it difficult, if not impossible, for automated systems to gain click-through access to an advertised Internet website without human intervention thereby rendering repeated automated access infeasible.

In an embodiment of the present invention, an interim landing page is provided by the retailer or a referring website, rather than a direct landing page as heretofore used to generate click counts. Passage through the interim landing page is required in order to gain access to the retailer's advertised web page. In order to pass through, a particular operation is required by a user or customer. Preferably, the operation cannot be performed by automated web access systems such as web-crawlers, spiders or bots.

One example of an access operation required on an interim landing page is entry of a security access code known to the user or consumer. The security access code can be provided via print advertising, other communication technique, another web page, or on the interim landing page itself. Any access code can be required, such as numbers, letters, other symbols or combinations thereof. If provided on the interim landing page, preferably the access code is provided in a graphical format, for which automated reading and understanding is not possible, or is difficult, time consuming or prone to error.

Other forms of access operations may be required such as speed-based entry, rhythmic codes, simultaneous combinations of keystrokes and/or mouse clicks or combinations of these operations.

According to one embodiment of the present invention, the interim landing page may be a part of the direct landing page. The direct landing page may include a portion of, for example, a product purchase page and the interim landing page. The interim landing page may include an input field that requires the user or consumer to input a security access code displayed in another portion of the interim landing page. To display the entire product purchase page, purchase the product or otherwise continue to the direct landing page, the user or consumer must first input the security access code into the input field.

In other embodiments of the present invention, an interim landing page is provided by the source or referring website, or an access operation is required either at the source or referring website or at the destination website, without provision of an interim landing page.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a diagrammatic illustration of an Internet commerce system in accordance with the present invention;

FIG. 2 is flowchart illustrating processing steps and modules in accordance with the present invention;

FIG. 3 is an illustration of an interim landing page in accordance with the present invention; and

FIG. 4 is a flowchart illustrating processing steps in accordance with the present invention.

### DETAILED DESCRIPTION OF THE INVENTION

In the following paragraphs, the present invention will be described in detail by way of example with reference to the accompanying drawings. Throughout this description, the preferred embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects.

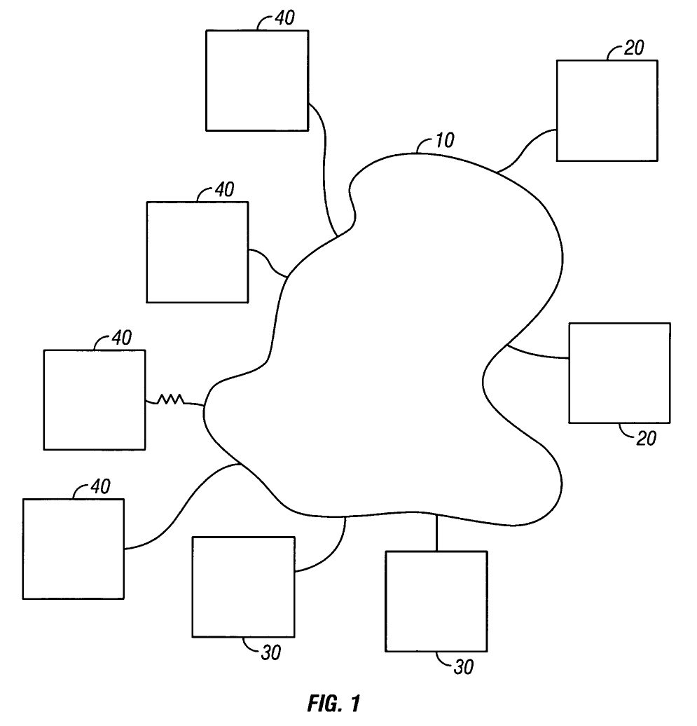

An Internet commerce system is illustrated in FIG. 1, in which reference number 10 points to a representation of an electronic communications network (“ECN”), such as the Internet. An advertising provider website is illustrated with reference number 20. Such a website is connected to the Internet for two-way communication to and from the advertising website provider's system 20. Advertiser websites are illustrated with reference number 30, and they will be referred to in this description as “Internet commerce websites” or “retailer websites”. Although any form of advertiser can practice the present invention, the preferred embodiment is described with reference to Internet commerce websites that offer for sale goods and/or services to consumers or businesses. Alternative examples of Internet commerce websites 30 are information providers, such as on-line news services, directories, encyclopedias, travel service providers and so on. Of course it is understood that such Internet commerce websites 30 can include one or more computer or server systems providing storage capacity storing database modules of product information and prices, product information pages, customer information, order information, etc.

In terms of hardware and software implementation, Internet commerce websites 30 and advertiser websites 20 can include the requisite computing equipment and software for storage of electronic or optical data, receiving and transmitting signals via an ECN, either wire or wireless, and providing to users 40 web page displays. For example, Internet commerce websites 30 include database modules storing secured access landing pages linked via locator information to selected advertising provider websites 20, as discussed further below. Also operating on the Internet are plural users (or consumers) who access the Internet via their access systems 40, whether computers, laptops, telephone handsets, cellular phones, personal data assistants (PDAs) and so on.

The invention is further described with reference to the Internet commerce websites' 30 method of operation, the advertising supplier's 20 method of operation, the business method practice providing click-through advertising security modules, and user's 40 shopping procedure.

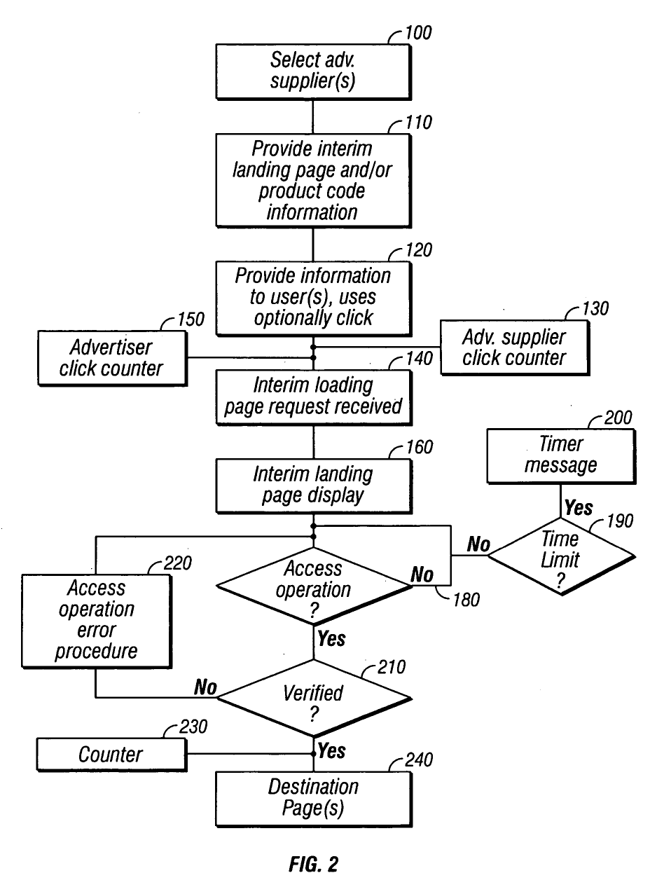

As a prerequisite of practicing the invention, an advertiser, such as Internet commerce website 30, selects specific desired advertising supplier websites 20 in which to purchase advertising. This selection process is graphically illustrated in FIG. 2 in step 100. Various forms of payment can be decided upon by the advertising supplier websites 20 and the retail websites 30. Although this invention is particularly directed to pay-by-click payment methods, any form of payment may be selected, such as, and without limitation, flat fee, barter and discounts can be selected as well. Preferably, the advertiser also provides Internet addresses for interim security landing pages, typically in the form of a URL, as illustrated in step 110. In one example, Internet addresses can be provided that link to interim landing pages that are specific to one or more particular products or services. For example, if a particular computer monitor is being sold (model “abc”), a particular link to an Address specific to an interim landing page specific to that product can be provided, and other products would have interim landing page Internet addresses associated with them. Alternatively, particular interim landing pages may be for plural products or services, each identified with a particular identifying code preferably provided to the advertising supplier website 20. The advertising supplier website 20 preferably maintains a database correlating particular advertised products and services with the interim landing page addresses and/or product codes (or service codes) provided in step 110 by the Internet commerce website(s) 30, and such a correlation database also preferably is maintained by the Internet commerce websites 30.

When the advertising supplier websites 20 are accessed by the users 40, the users 40 are provided with the option of clicking through to the Internet commerce websites 30 or to particular products/services offered by the Internet commerce websites 30, as illustrated in step 120. By clicking (it should be understood that “clicking” as used herein refers to any form of selection or designation operation), the Internet address for the interim landing page and optionally product/service codes provided in step 110 are supplied to the users 40 directing their Internet access software to a link via the Internet 10 to the specified Interim landing page of the Internet commerce website(s) 30. A click count optionally can be incremented by the advertising supplier websites 20 and/or the Internet commerce websites 30 tracking the number of clicks made for a particular ad, or particular Internet commerce website, as illustrated in by click count module 130.

Processing then proceeds to the Internet commerce website 30. The user request to view an interim landing page (via the URL and optional product or service code) is received at the Internet commerce website as illustrated in step 140. According to one embodiment of the present invention, the interim landing page may be presented as part of a direct landing page. The direct landing page may include a portion of the information desired by the user. A remaining portion of the direct landing page may be the interim landing page that may include a security access code and input field into which the user may input the security access code. If the user desires to view the direct landing page in its entirety, the user may input the security access code into the input field described in further detail below.

Optionally, advertising supplier website 20 and/or Internet commerce website 30 has a click counter module 150 tracking the number of clicks received, and optionally it tracks them by a particular advertisement or particular advertising supplier by receiving advertisement identifying information or advertising supplier website 20 identifying information from the advertising supplier via the user. For example, the Internet address code can carry advertisement codes, advertising website identifiers, product identifiers, cookies, or any other information signal allowing tracking and categorization of the clicks received. This counter module 150 provides raw data on the number of clicks, including both phantom types of clicks and legitimate user or consumer clicks.

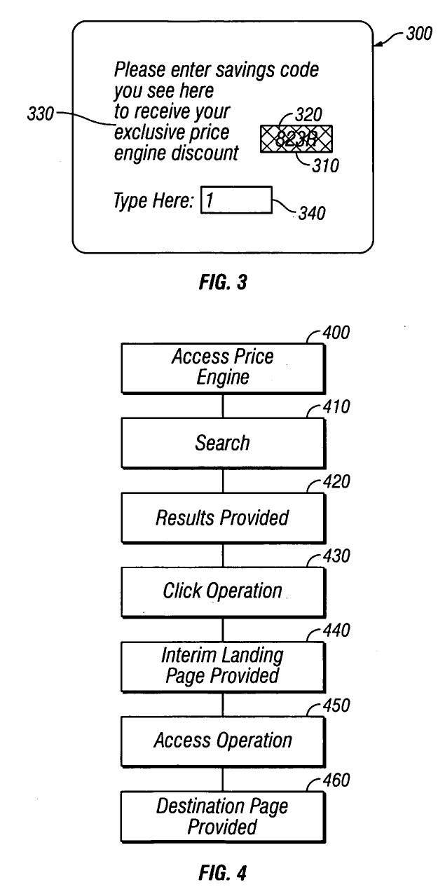

The interim landing page (illustrated in FIG. 3) of the Internet commerce website 30 is then provided to be displayed on the user system 40 from the Internet commerce website system 30 via the Internet 10, as illustrated in step 160. The Internet commerce website system 30 then waits for the user to conduct an operation required to pass from the interim landing page to the destination page, as illustrated with access operation decision module 170. If the user does not perform the requisite operation, the Internet commerce website system can continue waiting as illustrated with processing operation line 180. Other processing operations can be performed as well. For example, a timer module 190 can be added to provide a time limit for receipt of the access operation in decision module 170. If the time limit is exceeded, a timeout message is provided in step 200. If not, the system can continue to wait in decision module 170. Alternatively, if an operation is conducted, verification is performed in verification module 210. If an incorrect operation is performed, such as typographic error in inputting an access code, an error procedure 220 is performed. This alternatively can include simply returning to the decision module 170, displaying a modified interim landing page, such as stating “please try again” or “error, please try again”. Optionally, a new access security code also is provided. Following the error processing, the system can return to the decision module 170 to await performance of a correct access operation.

Once a correct access operation is performed, processing in the Internet commerce website system 30 can proceed to sending the ultimate destination page to the user system 40, as illustrated in module 240. Examples of destination pages can be product information pages, special sale pages or promotion pages, a checkout page, a news story, etc. Preferably, a counter module 230 is provided that tracks the number of successful access operations received, and optionally it tracks them by a particular advertisement or by particular adverting suppliers or groups of advertisements and/or suppliers. For example, the URL can carry advertisement codes, advertising website identifiers, product identifiers, cookies, or any other information signal allowing tracking and categorization of the clicks received. This provides data on the number of legitimate clicks received, i.e., click-through from the advertiser website system 30 from users who successfully receive and enter the requisite access operation. It should be noted that the Internet commerce website optionally can report the count of successful access operations received to the advertising provider website, and the count optionally can be used as the basis for determining the fee owned on a pay-by-click basis. This way, more accurate reporting of click counts is provided by eliminating or reducing the number of phantom counts reported.

An example of an interim landing page 300 is illustrated in FIG. 3. It should be noted that any form or format of the interim landing page may be selected so long as a particular access operation is required by the user, in order to pass through the landing page on to a destination page. In the illustrated example, the access operation is entry of an access code 310, which can be called a “savings code” as illustrated in FIG. 3. The access code 310 can be any code, such as numbers, letters, other symbols or combinations thereof. Preferably, the access code 310 is provided in a graphical illustration, such as an image file in an image format (such as jpeg, gif, pdf, etc.) or a bitmap format, rather than in ASCII code. To further inhibit automated detection and entry of the access code 310, it also is preferred that the access code 310 be displayed against a graphic background 320. A user instruction 230 optionally can be provided to help guide inexperienced users. Likewise, an access code entry field 340 optionally is provided. Alternatively, a field 340 is not provided and the user can type in the code at will. It should be noted that an access code 340 is only an illustration of the operation performed on the interim landing page. Other operations include, such as, for example and without limitation, rhythmic or timed keystrokes or clicks, simultaneous combinations of keystrokes or clicks, sound or graphic input or other operation.

In another embodiment, access operation instructions or an access code 310 is not provided on the landing page 300, but is provided by the advertising provider 20, such as in an advertisement or before the user exits the advertising provider 20 websites. Alternatively, an access code or access operation instruction is provided by other communication methods to user(s) 40, such as via television, third party website, print advertising, flyers, radio, and so on.

It should be understood that the interim landing page can be provided at any desired location, or eliminated entirely so long as the objective of providing access operation required access to destination page information is provided. For example, the interim landing page 160 can be provided while the user is at the source or referring website, such as the advertising supplier website. In this alternative, the user access operation is performed at the source or referring website prior to moving to the destination website (such as the advertiser website). In this embodiment, the verification steps 180, 190, 200, 210 and 220 optionally can be performed at the source or referring website. Likewise the counter 230 optionally can be provided at the source or referring website. In an alternative, the destination page 240 also is provided at the source or referring website. If a purchase is to be made based on the destination page 240, the user optionally is directed to the destination website.

Likewise, where the interim landing page is not used, access information is provided either on the source or referral website, or alternatively at the destination page 240. In such an embodiment, an access operation is required either at the source or referring website or at the destination website, without provision of an interim landing page.

An alternative illustration of a price engine embodiment of the present invention is provided in FIG. 4. In step 400, the user accesses a price engine, having a pay-by-click advertising implementation. The user searches for a desired product, service or information using a search feature implemented in the search engine, as illustrated in step 410. A listing of merchants (i.e. Internet commerce websites) and corresponding product/service prices is sent from the price engine to the user system 40, as depicted in step 420. The user then selects a merchant, such via an input technique, such as clicking, or other form of input as illustrated in step 430. An interim landing page (such as any form of access restricting or limiting page) is sent from the merchant system 30 via the Internet 10 to the user system 40, as illustrated in step 440. The user then performs the required access operation, as illustrated in step 450 and a destination page is provided from the merchant to the user, as illustrated in step 460 from the user system's 40 point of view. Of course the merchant system preferably performs verification operations such as discussed previously to verify that the user has performed the correct access operation.

Thus, it is seen that a system and method of reducing phantom clicks and providing advertising data are provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

1. A method of conducting Internet commerce providing click-through access from a first website to a second website comprising:
requesting access to a second website from a first website;
requiring receipt by the second website of an access operation input; and
providing a destination page from the second website after receipt of the access operation input.

2. The method as recited in claim 1 further comprising:
counting the number of times correct access operation inputs are received by the second website; and
generating a click count corresponding to the number of correct access operations.

3. The method as recited in claim 2 further comprising:
using the click count corresponding to the number of correct access operations as the basis for determining a fee owned on a pay-by-click basis by the second website to the first website.

4. The method as recited in claim 2 further comprising:
reporting the click count to the first website.

5. The method as recited in claim 1 further comprising:
entering into a pay-by-click advertising agreement between the first website and the second website.

6. The method as recited in claim 1 further comprising:
providing an interim landing page.

7. The method as recited in claim 6 further comprising:
supplying Internet address identifying information from the second website corresponding to the interim landing page.

8. The method as recited in claim 6 further comprising:
user selection of the identifying information to signal the second website to provide the interim landing page data to the user making the selection.

9. The method as recited in claim 1 wherein the first website comprises an advertising provider website and the second website comprises an Internet commerce website.

10. A system of inhibiting automated click-through access to a second website from a first website comprising:
a website access requesting module that requests access from a first website to a second website;
an access code decision module requiring receipt by the second website of an access operation input; and
a providing module sending destination page data from the second website after receipt of the access operation input.

11. The system as recited in claim 10 further comprising a counter tracking correct access operation inputs are received in the second website and generating a click count corresponding to the number of correct access operations.

12. The system as recited in claim 111 further comprising a determining module using the click count corresponding to the number of correct access operations as the basis for determining a fee owned on a pay-by-click basis by the second website to the first website.

13. The system as recited in claim 11 further comprising a reporting module transmitting the click count to the first website.

14. The system as recited in claim 10 further comprising an interim page landing providing module that provides an interim landing page.

15. The system as recited in claim 10 wherein the first website comprises an advertising provider website and the second website comprises an Internet commerce website.

16. A method of conducting commerce via an electronic communications network in which a second website advertises via a first website, the method comprising:
requesting access to a second website from a first website;
requiring receipt by the second website of an access operation input; and
providing a destination page from the second website after receipt of the access operation input, the destination page providing data pertaining to a product or service for sale via the second website.

17. The method as recited in claim 16 further comprising:
counting times correct access operation inputs are received by the second website, generating a click count corresponding to the number of correct access operations.

18. The method as recited in claim 17 further comprising:
using the click count corresponding to the number of correct access operations as the basis for determining the fee owned on a pay-by-click basis by the second website to the first website.

19. The method as recited in claim 17 further comprising:
reporting the click count to the second website.

20. The method as recited in claim 16 further comprising:
entering into a pay-by-click advertising agreement between the first website and the second website.

21. The method as recited in claim 16 further comprising:
providing an interim landing page.

22. The method as recited in claim 21 further comprising:
supplying Internet address identifying information from the second website corresponding to the interim landing page.

23. The method as recited in claim 22 further comprising:
user selection of the identifying information to signal the second website to provide interim landing page data to the user making the selection.

24. The method as recited in claim 16 wherein the first website comprises an advertising provider website and the second website comprises an Internet commerce website.
